(19) United States
(12) Patent Application Publication
(10) Pub. No.: US 2026/0072184 A1
(43) Pub. Date: Mar. 12, 2026

(54) PHOTOELECTRIC SENSING DEVICE

(71) Applicant: InnoCare Optoelectronics Corporation, Tainan City (TW)

(72) Inventor: Chih-Hao Wu, Tainan City (TW)

(73) Assignee: InnoCare Optoelectronics Corporation, Tainan City (TW)

(21) Appl. No.: 19/299,327

(22) Filed: Aug. 13, 2025

(30) Foreign Application Priority Data
Sep. 12, 2024 (TW) 113134570

(51) Int. Cl. G01T 1/20; G01T 1/24

(52) U.S. Cl. CPC G01T 1/2018; G01T 1/24

(57) ABSTRACT

A photoelectric sensing device including a transistor, a photoelectric sensing element, a planarization layer, a bias line, a scintillator layer and a wiring layer. The photoelectric sensing element is electrically connected to the transistor. The planarization layer is disposed on the photoelectric sensing element. The bias line is disposed on the planarization layer in an active area. The scintillator layer is disposed on the planarization layer. The wiring layer is disposed between the bias line and a pad located in a peripheral area. The photoelectric sensing device includes a first area and a second area. The first area is an area where the scintillator layer is located, and the second area is an area other than the first area, wherein at least part of the wiring layer located in the second area is not covered by the planarization layer or is located below the planarization layer.

### CROSS-REFERENCE TO RELATED APPLICATION

This application claims the priority benefit of Taiwan application Ser. No. 113134570, filed on Sep. 12, 2024. The entirety of the above-mentioned patent application is hereby incorporated by reference herein and made a part of this specification.

### BACKGROUND

### Technical Field

The disclosure relates to an electronic device, and in particular to a photoelectric sensing device.

### Description of Related Art

In a manufacturing process of electronic device, the relatively uneven surface of a layer would be flattened by forming a planarization layer, so as to facilitate the subsequent processes of electronic device. However, the planarization layer made of the organic material has relatively poor rigidity, which would be easily damaged when struck by the foreign objects.

For example, in a manufacturing process of photoelectric sensing device, before forming a scintillator layer through an evaporation process, an evaporation jig is first used to cover an area where the scintillator layer is not to be formed. However, there had been the planarization layer and the wiring layer located on the planarization layer. When the planarization layer is damaged by the evaporation jig during the evaporation process, the wiring layer would be disconnected due to the scratch from the evaporation jig and/or the uneven topography from the planarization layer, resulting in the reduced reliability or functional failure of the formed photoelectric sensing device.

### SUMMARY

The disclosure provides a photoelectric sensing device, which has the improved reliability.

In an embodiment of the disclosure, the photoelectric sensing device includes a transistor, a photoelectric sensing element, a planarization layer, a bias line, a scintillator layer, and a wiring layer. The transistor is disposed on a substrate. The photoelectric sensing element is disposed on the substrate and is electrically connected to the transistor. The planarization layer is disposed on the photoelectric sensing element and partially covers the photoelectric sensing element. The bias line is disposed on the planarization layer in an active area and is electrically connected to the photoelectric sensing element. The scintillator layer is disposed on the planarization layer. The wiring layer is disposed between the bias line and a pad located in a peripheral area, and is electrically connected to the bias line and the pad. The photoelectric sensing device comprises a first area and a second area, the first area is an area where the scintillator layer is located, and the second area is an area other than the first area. At least part of the wiring layer located in the second area is not covered by the planarization layer or is located below the planarization layer.

Based on the above, in the photoelectric sensing device provided by the embodiment of the disclosure, when the scintillator layer is formed by performing an evaporation process, the evaporation jig covering the second area is difficult to affect the wiring layer since at least part of the wiring layer located in the second area is not covered by the planarization layer or is located below the planarization layer. Therefore, the disconnection of the wiring layer located in the second area could be reduced, thereby improving the reliability of the photoelectric sensing device.

### BRIEF DESCRIPTION OF THE DRAWINGS

The drawings are included to provide a further understanding of the disclosure, and the drawings are incorporated into the specification and constitute a part of the specification. The drawings illustrate embodiments of the disclosure and serve to explain principles of the disclosure together with the description.

FIG. 1 is a partial top schematic view of a photoelectric sensing device according to an embodiment of the disclosure.

FIG. 2A is an enlarged top schematic view of a first embodiment of a region R according to FIG. 1.

FIG. 2B is a schematic cross-sectional view of an embodiment taken along a cross-section line A-A′ of FIG. 2A.

FIG. 3A is an enlarged top schematic view of a second embodiment of a region R according to FIG. 1.

FIG. 3B is a schematic cross-sectional view of an embodiment taken along a cross-section line B-B′ of FIG. 3A.

FIG. 4A is an enlarged top schematic view of a third embodiment of a region R according to FIG. 1.

FIG. 4B is a schematic cross-sectional view of an embodiment taken along a cross-section line C-C′ of FIG. 4A.

### DESCRIPTION OF THE EMBODIMENTS

The disclosure can be understood by referring to the following detailed description in combination with the accompanying drawings. It should be noted that in order to make it easy for the reader to understand and for the simplicity of the drawings, the multiple drawings in this disclosure only depict a part of the electronic device, and the specific components in the drawings are not drawn according to actual scale. In addition, the number and size of each component in the drawings are only for exemplary purpose, and are not intended to limit the scope of the disclosure Throughout the disclosure and the appended claims, certain words are used to refer to specific components. Those skilled in the art should understand that electronic device manufacturers may refer to the same components by different names. The disclosure does not intend to distinguish those components with the same function but different names. In the following description and claims, the terms “including”, “containing”, and “having” are open-ended terms, so they should be interpreted as “include but not limited to . . . ”. Therefore, when the terms “including”, “containing”, and/or “having” are used in the description of this disclosure, they specify the existence of a corresponding feature, region, step, operation, and/or component, but do not exclude the existence of one or more corresponding features, regions, steps, operations, and/or components.

Direction terms mentioned in this specification, such as such as “up,” “down,” “front,” “back,” “left,” and “right,” merely refer to directions in the accompanying drawings. Therefore, the direction terms used is for illustration, not for limiting this disclosure. In the drawings, each drawing shows the general features of the method, structure, and/or material used in a specific embodiment. However, these drawings should not be construed as defining or limiting the scope or nature of the embodiments. For example, for the sake of clarity, the relative size, thickness, and position of each layer, region, and/or structure may be reduced or enlarged.

When a corresponding member (such as a layer or a region) is described as being “on another member,” it may be directly on another member, or there may be other member therebetween. On the other hand, when a member is described as being “directly on another member,” no member exists therebetween. In addition, when a member is described as being “on another member,” the two have a vertical relationship in the top view direction, and this member may be located above or below the other member, and the vertical relationship depends on the device orientation.

The terms “approximately”, “essentially”, or “substantially” are generally interpreted as within 10% of a given value or range, or as within 5%, 3%, 2%, 1%, or 0.5% of the value or range.

Ordinal numbers in this specification and the claims such as “first” and “second” are used to modify a component, and do not imply or represent that the (or these) component(s) has (or have) any ordinal number, and do not indicate any order between a component and another component, or an order in a manufacturing method. These ordinal numbers are merely used to clearly distinguish a component having a name with another component having the same name. Different terms may be used in the claims and the specification, so that a first member in the specification may be a second member in the claims.

It should be understood that the following embodiments may replace, reorganize, and mix the features in several different embodiments to complete other embodiments without departing from the spirit of the disclosure. As long as the features of the embodiments do not violate the spirit of the disclosure or conflict each other, they may be mixed and matched as desired.

Electrical connection or coupling described in the disclosure may refer to direct connection or indirect connection. In the case of direct connection, end points of the components on two circuits are directly connected or connected to each other with a conductor segment, and in the case of indirect connection, there are transistors, diodes, capacitors, inductors, other suitable components, or a combination of the above components between the end points of the components on the two circuits, but the disclosure is not limited thereto.

In the disclosure, a thickness, a length, and a width may be measured using an optical microscope, and the thickness may be measured using a cross-sectional image in an electronic microscope. However, the disclosure is not limited thereto. In addition, any two values or directions used for comparison may have certain errors. If a first direction is perpendicular to a second direction, an angle between the first direction and the second direction may be between 80 degrees and 100 degrees. If the first direction is parallel to the second direction, the angle between the first direction and the second direction may be between 0 degrees and 10 degrees.

The electronic device in the disclosure could include a detection device, a display device, an antenna device (such as a liquid crystal antenna), a light-emitting touch device, a tiled device, a device with other suitable functions, or a combination of devices with the above functions, but the disclosure is not limited thereto. The electronic devices could include rollable electronic devices or flexible electronic devices, but the disclosure is not limited thereto. The electronic device could include liquid crystal, light emitting diode (LED), quantum dot (QD), fluorescence, phosphorescence, other suitable display media or a combination thereof. The light emitting diode could include organic light emitting diode (OLED), micro light emitting diode (micro-LED), sub-millimeter light emitting diode (mini-LED) or quantum dots light emitting diode (QDLED), but the disclosure is not limited thereto. It should be noted that the electronic device could be any of the above-mentioned arrangements and combinations, but the disclosure is not limited thereto. In addition, the shape of the electronic device could be a rectangular shape, a circular shape, a polygonal shape, a shape with curved edges, or other suitable shapes. The display device could have peripheral systems such as drive systems, control systems, light source systems, shelf systems, and so on, so as to support the display devices or the tiled devices. It should be noted that the electronic device could be any of the above-mentioned arrangements and combinations, but the disclosure is not limited thereto. The electronic device may include a plurality of components, in which at least two components may be assembled to form a composite. In the following embodiments, a sensing device will be used as the electronic device to illustrate the disclosure, but the disclosure is not limited thereto.

Reference will now be made in detail to the exemplary embodiments of the disclosure and the same reference numbers are used in the drawings and descriptions to refer to the same or similar parts.

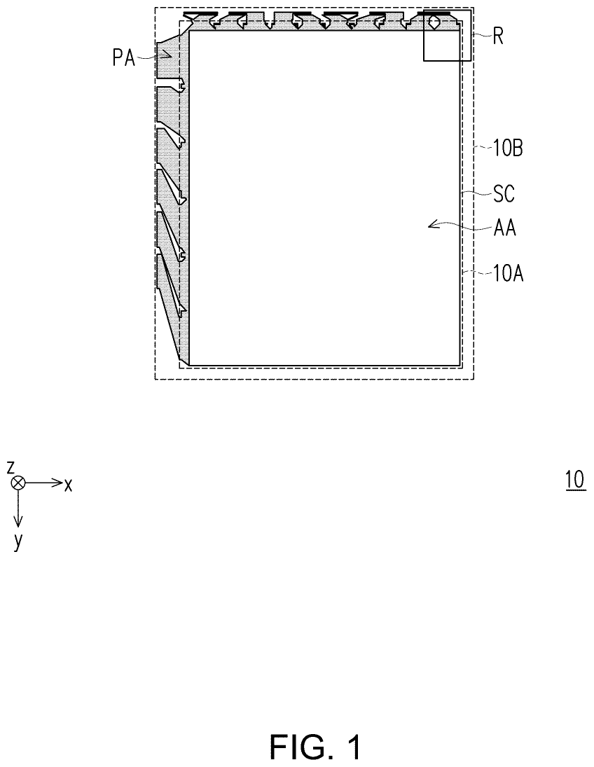

FIG. 1 is a partial top schematic view of a photoelectric sensing device according to an embodiment of the disclosure.

Referring to FIG. 1, a photoelectric sensing device 10 includes an area 10A and an area 10B, where the area 10A is defined as an area where a scintillator layer SC is located in a top view direction z of the photoelectric sensing device 10, and the area 10B is defined as an area other than the area 10A. The area 10A includes an active area AA, and the area 10B includes a peripheral area PA surrounding the area 10A. The detailed structure of the photoelectric sensing device 10 would be described below with reference to the plurality of embodiments, but the disclosure is not limited thereto.

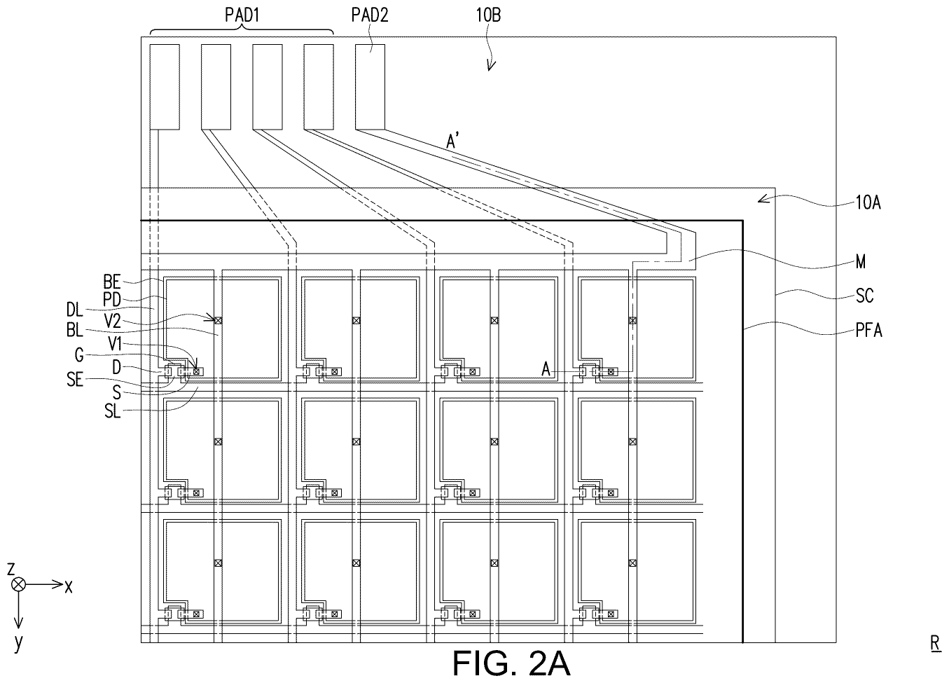

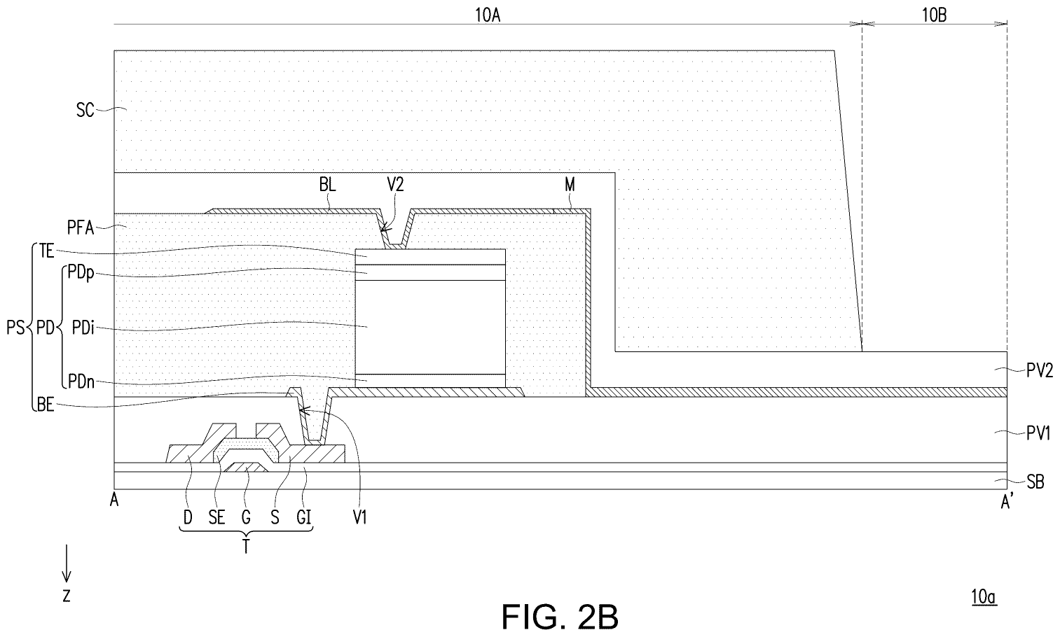

FIG. 2A is an enlarged top schematic view of a first embodiment of a region R according to FIG. 1, and FIG. 2B is a schematic cross-sectional view of an embodiment taken along a cross-section line A-A′ of FIG. 2A.

Referring to FIGS. 2A and 2B, in the present embodiment, a photoelectric sensing device 10a includes a transistor T, a photoelectric sensing element PS, a planarization layer PFA, a bias line BL, a scintillator layer SC, and a wiring layer M. In some embodiments, the photoelectric sensing device 10a could be a direct-detection X-ray sensor or an indirect-detection X-ray sensor, but the disclosure is not limited thereto.

The transistor T is disposed on a substrate SB. In some embodiments, a material of the substrate SB could include a hard material, a soft material, or a combination thereof. For example, the material of the substrate SB could include quartz, sapphire, polymethyl methacrylate (PMMA), polycarbonate (PC), polyimide (PI), polyethylene terephthalate (PET), or other suitable materials or a combination thereof, but the disclosure is not limited thereto.

In the present embodiment, the transistor T includes a gate G, a gate dielectric layer GI, a semiconductor layer SE, a source S, and a drain D.

The gate G is disposed on the substrate SB. In some embodiments, a material of the gate G could include molybdenum (Mo), titanium (Ti), tantalum (Ta), niobium (Nb), hafnium (Hf), nickel (Ni), chromium (Cr), cobalt (Co), zirconium (Zr), tungsten (W), aluminum (Al), copper (Cu), silver (Ag), other suitable metals, or alloys or a combination thereof, but the disclosure is not limited thereto.

The gate dielectric layer GI is disposed on the gate G, and covers the gate G. In some embodiments, a material of the gate dielectric layer GI could include inorganic materials (such as silicon oxide, silicon nitride, silicon oxynitride, or stacked layers of at least two of the above materials), organic materials (such as polyimide resin, epoxy resin or acrylic resin) or a combination thereof, but the disclosure is not limited thereto.

The semiconductor layer SE is disposed on the gate dielectric layer GI, and at least partially overlaps the gate G in the top view direction z of the photoelectric sensing device 10a. In the present embodiment, a material of the semiconductor layer SE includes metal oxide. The metal oxide could include indium gallium zinc oxide (IGZO), indium zinc oxide (IZO), indium gallium zinc oxide (IGZTO), or organic semiconductors including polycyclic aromatic compounds, or a combination thereof, but the disclosure is not limited thereto. In other embodiments, the material of the semiconductor layer SE includes silicon, which could include low temperature polysilicon (LTPS) or amorphous silicon (a-Si), but the disclosure is not limited thereto. For example, the material of the semiconductor layer SE could include amorphous silicon, polycrystalline silicon, germanium, compound semiconductors (such as gallium nitride, silicon carbide, gallium arsenide, gallium phosphide, indium phosphide, indium arsenide and/or indium antimonide), alloy semiconductors (such as SiGe alloy, GaAsP alloy, AlInAs alloy, AlGaAs alloy, GaInAs alloy, GaInP alloy, GaInAsP alloy) or a combination thereof, but the disclosure is not limited thereto.

The source S and the drain D are disposed on the semiconductor layer SE, and are separated from each other. In the present embodiment, the source S and the drain D are in direct contact with the semiconductor layer SE and are electrically connected thereto, but the disclosure is not limited thereto. A material of the source S and a material of the drain D could be the same or similar as that of the gate G, so the corresponding descriptions would be omitted here.

In the present embodiment, the photoelectric sensing device 10a further includes an insulating layer PV1. The insulating layer PV1 is disposed on the transistor T. In the present embodiment, the insulating layer PV1 partially covers the source S of the transistor T. In detail, the insulating layer PV1 has a through hole V1 exposing a portion of the source S, but the disclosure is not limited thereto. A material of the insulating layer PV1 could include inorganic materials (such as silicon oxide, silicon nitride, silicon oxynitride or a stacked layer of at least two of the above materials), organic materials (such as polyimide resin, epoxy resin or acrylic resin) or a combination thereof, but the disclosure is not limited thereto. In the present embodiment, the material of the insulating layer PV1 is silicon nitride, but the disclosure is not limited thereto.

The photoelectric sensing element PS is disposed on the substrate SB, and is electrically connected to the transistor T. In the present embodiment, the photoelectric sensing element PS is disposed on the insulating layer PV1. The photoelectric sensing element PS could overlap the transistor T or not overlap the transistor T in the top view direction z of the photoelectric sensing device 10a, but the disclosure is not limited thereto. In the present embodiment, the photoelectric sensing element PS includes a lower electrode BE, an upper electrode TE and a semiconductor PD, wherein the semiconductor PD is disposed between the lower electrode BE and the upper electrode TE in the top view direction z of the photoelectric sensing device 10a. A portion of the lower electrode BE could be disposed in the through hole V1 of the insulating layer PV1, so that the photoelectric sensing element PS could be electrically connected to the source S of the transistor T through the lower electrode BE. In addition, the photoelectric sensing element PS could be electrically connected to a bias line BL through the upper electrode TE, which will be introduced later. In some embodiments, a material of the lower electrode BE and a material of the upper electrode TE could include a transparent conductive material, which could be indium tin oxide (ITO), but the disclosure is not limited thereto. A material of the semiconductor PD could include amorphous silicon, but the disclosure is not limited thereto. In other embodiments, the semiconductor PD could include single crystal material or polycrystalline material. In some embodiments, the semiconductor PD includes a first layer PDn, an intrinsic layer PDi and a second layer PDp, and the first layer PDn, the intrinsic layer PDi and the second layer PDp are stacked in the top view direction z of the photoelectric sensing device 10a in this sequence, but the disclosure is not limited thereto.

In the present embodiment, the photoelectric sensing device 10a further includes a scan line SL and a data line DL. The scan line SL is disposed on the substrate SB and is electrically connected to the gate G of the transistor T. The scan line SL could be used to provide a scan signal to the corresponding transistor T to turn it on. In some embodiments, the scan line SL extends toward a direction x, but the disclosure is not limited thereto. In the present embodiment, the scan line SL and the gate G belong to the same conductive layer. Therefore, a material of the scan line SL could be the same as the material of the gate G, so the corresponding descriptions would be omitted here. The data line DL is disposed on the substrate SB and is electrically connected to the drain D of the transistor T. The signal (the carrier) generated by the photoelectric sensing element PS could be transmitted to the data line DL through the drain D, and the signals (the carrier) could be transmitted to the processing circuit (not shown) through the data line DL. In some embodiments, the data line DL extends toward a direction y, but the disclosure is not limited thereto. In the present embodiment, the data line DL, the source S and the drain D belong to the same conductive layer, but the disclosure is not limited thereto.

The planarization layer PFA is disposed on the photoelectric sensing element PS, and partially covers the photoelectric sensing element PS. In the present embodiment, the planarization layer PFA partially covers the upper electrode TE of the photoelectric sensing element PS. In detail, the planarization layer PFA has a through hole V2 exposing a portion of the upper electrode TE, but the disclosure is not limited thereto. A material of the planarization layer PFA could be an organic material, such as polyimide resin, epoxy resin, acrylic resin or a combination thereof, but the disclosure is not limited thereto.

The bias line BL is disposed on the planarization layer PFA in the active area AA, and is electrically connected to the photoelectric sensing element PS. In detail, a portion of the bias line BL could be disposed in the through hole V2 of the planarization layer PFA, so that the bias line BL could be electrically connected to the upper electrode TE of the photoelectric sensing element PS for applying a voltage to the photoelectric sensing element PS. In some embodiments, the bias line BL extends toward the direction y, but the disclosure is not limited thereto.

In the present embodiment, the photoelectric sensing device 10a further includes an insulating layer PV2. The insulating layer PV2 is disposed on the planarization layer PFA and covers the bias line BL. In addition, in the present embodiment, the insulating layer PV2 could cover the photoelectric sensing element PS and could be used to protect the photoelectric sensing element PS. A material of the insulating layer PV2 could include inorganic materials (such as silicon oxide, silicon nitride, silicon oxynitride or a stacked layer of at least two of the above materials), organic materials (such as polyimide resin, epoxy resin or acrylic resin) or a combination thereof, but the disclosure is not limited thereto. In the present embodiment, the material of the insulating layer PV2 is silicon nitride, but the disclosure is not limited thereto.

The scintillator layer SC is disposed on the planarization layer PFA. In the present embodiment, the scintillator layer SC is disposed on the insulating layer PV2. In some embodiments, the scintillator layer SC could be formed on the planarization layer PFA through performing an evaporation process. In detail, a surface of the planarization layer PFA away from the substrate SB could be faced to the evaporation source (not shown), and the evaporation jig (not shown) could be used to cover the area 10B and expose the area 10A, and then the evaporation source could be heated. After that, the source material (not shown) is generated, and the evaporation source material is deposited in the area 10A to form the scintillator layer SC. A material of the scintillator layer SC includes a material that efficiently converts the energy of radiation (such as X-rays) incident from the outside into the visible light. In some embodiments, the material of the scintillator layer SC could include cesium iodide (CsI), sodium iodide (NaI), thallium iodide (TlI), gallium dioxide sulfide (Gd₂O₂S) or other suitable materials. In the present embodiment, the material of the scintillator layer SC includes cesium iodide, but the disclosure is not limited thereto.

In the present embodiment, the scintillator layer SC overlaps the planarization layer PFA in the top view direction z of the photoelectric sensing device 10a, and a surface area of the scintillator layer SC in the top view direction z of the photoelectric sensing device 10a is greater than a surface area of the planarization layer PFA in the top view direction z of the photoelectric sensing device 10a. In other words, in the present embodiment, the planarization layer PFA is disposed in the area 10A and is not disposed in the area 10B, but the disclosure is not limited thereto.

Please refer to FIG. 2A, in the present embodiment, the photoelectric sensing device 10a further includes a pad PAD1 and a pad PAD2.

The pad PAD1 is disposed in the peripheral area PA of the area 10B. In some embodiments, the pad PAD1 is electrically connected to the data line DL, so that the data line DL could transmit the signal (the carrier) to the processing circuit (not shown) through the pad PAD1, but the disclosure is not limited thereto.

The pad PAD2 is disposed in the peripheral area PA of the area 10B. In some embodiments, the pad PAD2 is electrically connected to the bias line BL, so that the bias line BL could apply the voltage to the photoelectric sensing element PS through the voltage supply element (not shown) electrically connected to the pad PAD2, but the disclosure is not limited thereto.

The wiring layer M is disposed between the bias line BL and the pad PAD2, and is electrically connected to the bias line BL and the pad PAD2. In detail, the plurality of bias lines BL could be merged into one line through the wiring layer M and electrically connected to the pad PAD2. In the present embodiment, the wiring layer M and the bias line BL belong to the same layer, but the disclosure is not limited thereto. In addition, in the present embodiment, the planarization layer PFA is not located in the area 10B. Therefore, the wiring layer M located in the area 10B is disposed on the insulating layer PV1. Alternatively, at least part of the wiring layer M located in the area 10B is not covered by the planarization layer PFA.

Based on the above, when the scintillator layer SC is formed by performing the evaporation process, the evaporation jig covering the area 10B is difficult to affect the planarization layer PFA since the planarization layer PFA is not located in the area 10B. Therefore, the possibility of damage to the planarization layer PFA could be lowered, so as to reduce the disconnection of the wiring layer M located on the planarization layer PFA.

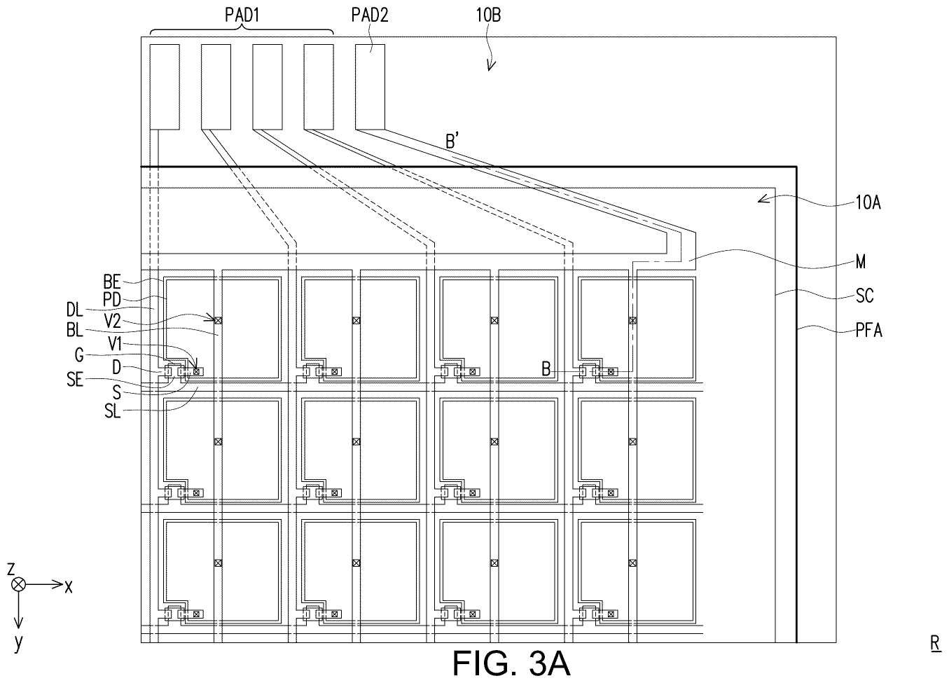

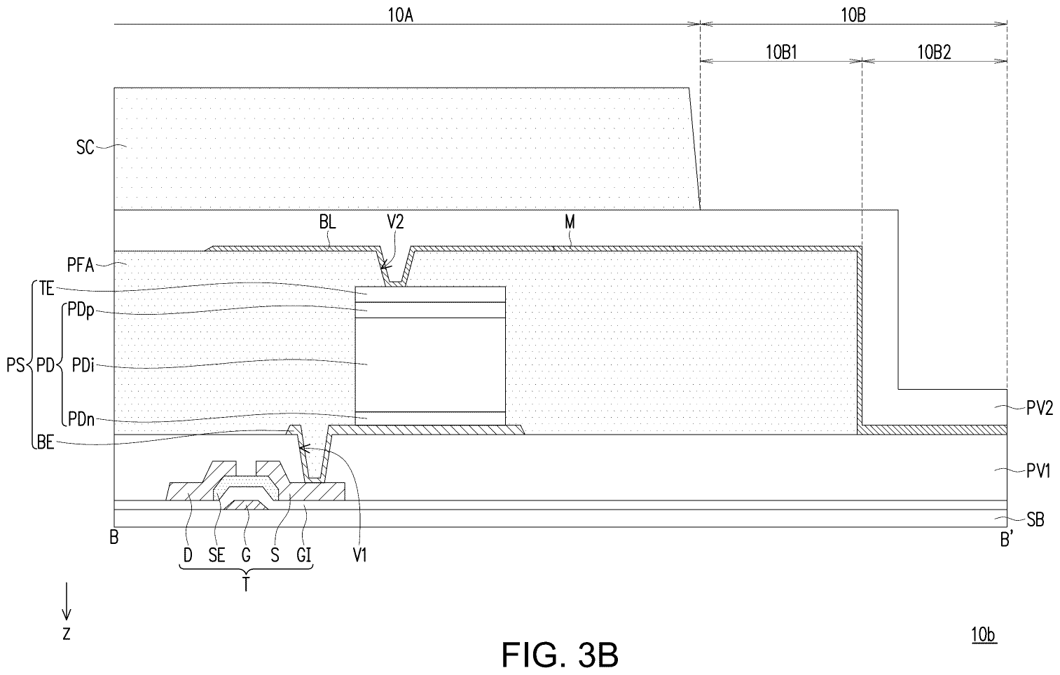

FIG. 3A is an enlarged top schematic view of a second embodiment of a region R according to FIG. 1, and FIG. 3B is a schematic cross-sectional view of an embodiment taken along a cross-section line B-B′ of FIG. 3A. It should be noted that the embodiment of FIGS. 3A and 3B could respectively use the reference numbers and portions of the content of the above embodiment of FIGS. 2A and 2B, wherein the same or similar reference numbers are used to represent the same or similar elements, and descriptions of the same technical contents are omitted.

Referring to FIGS. 3A and 3B, the main difference between a photoelectric sensing device 10b of the present embodiment and the photoelectric sensing device 10a is that the planarization layer PFA is further formed in the area 10B. Therefore, the surface area of the planarization layer PFA would be larger than the surface area of the scintillator layer SC in the top view direction z of the photoelectric sensing device 10b.

In the present embodiment, the area 10B is divided into a sub-area 10B1 and a sub-area 10B2, in which an area where the planarization layer PFA is located in the area 10B is defined as the sub-area 10B1, and an area where the planarization layer PFA is not located in the area 10B is defined as the sub-area 10B2. Therefore, the sub-area 10B2 could surround the sub-area 10B1. From another perspective, the wiring layer M is disposed on the planarization layer PFA in the sub-area 10B1, and the wiring layer M is not disposed on the planarization layer PFA in the sub-area 10B2 (in which the wiring layer M is disposed on the insulating layer PV1).

In the present embodiment, a surface area of the wiring layer M located in the sub-area 10B1 is smaller than a surface area of the wiring layer M located in the sub-area 10B2 in the top view direction z of the photoelectric sensing device 10b. For example, a ratio of the surface area of the wiring layer M located in the sub-area 10B1 to the surface area of the wiring layer M located in the sub-area 10B2 is less than one-ninth, but the disclosure is not limited thereto.

Based on the above, when the scintillator layer SC is formed by performing the evaporation process, the possibility of disconnection of the wiring layer M located on the planarization layer PFA due to the evaporation jig covering the area 10B could be lowered since the surface area of the wiring layer M located in the sub-area 10B1 is smaller than the surface area of the wiring layer M located in the sub-area 10B2.

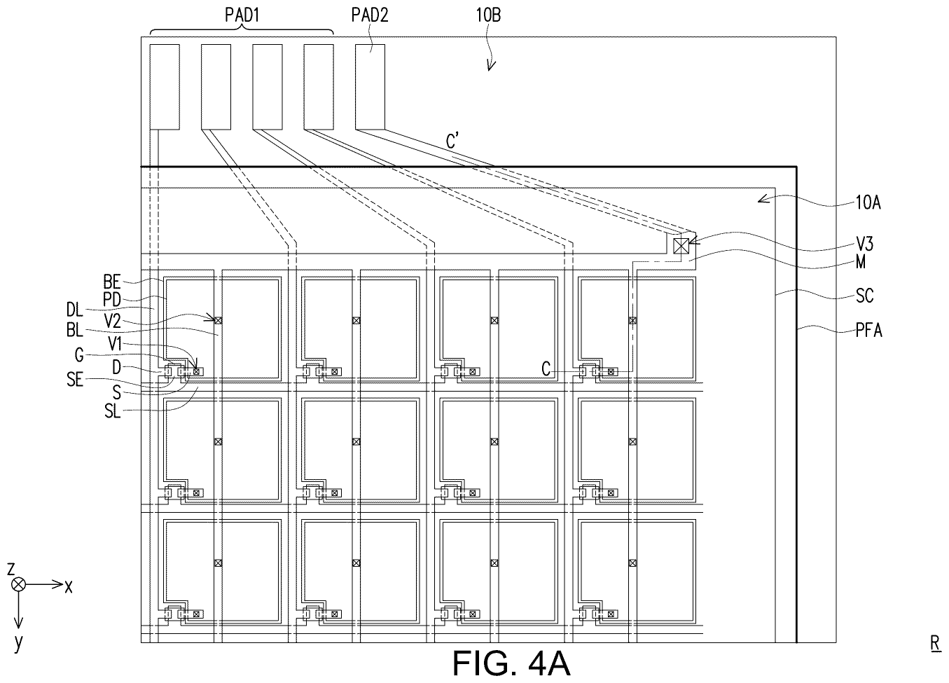

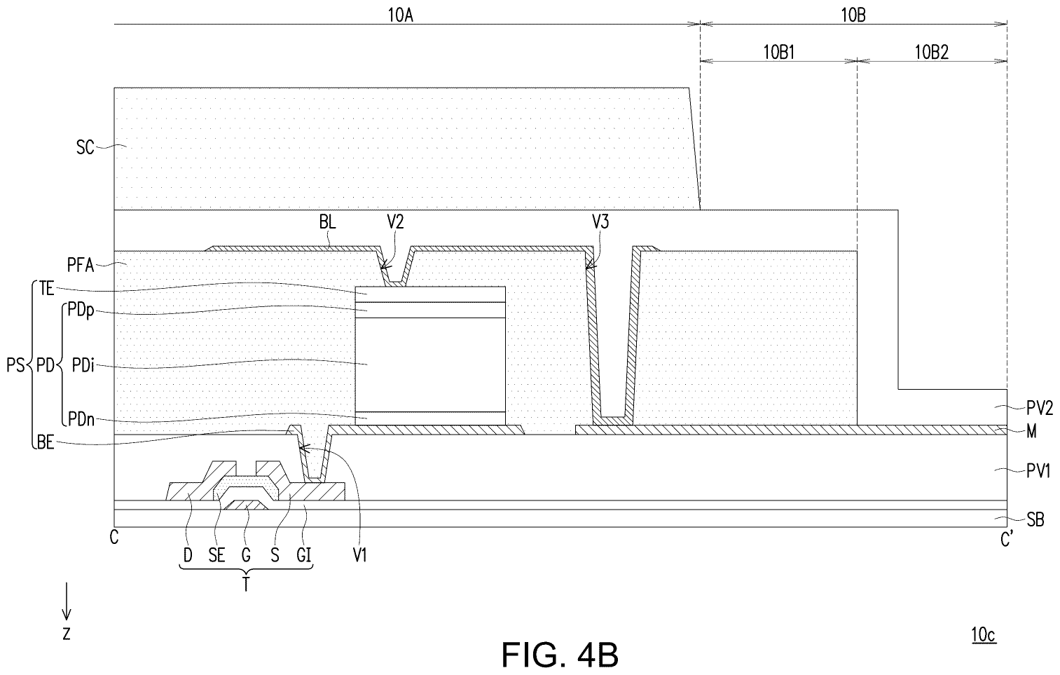

FIG. 4A is an enlarged top schematic view of a third embodiment of a region R according to FIG. 1, and FIG. 4B is a schematic cross-sectional view of an embodiment taken along a cross-section line C-C′ of FIG. 4A. It should be noted that the embodiment of FIGS. 4A and 4B could respectively use the reference numbers and portions of the content of the above embodiment of FIGS. 3A and 3B, wherein the same or similar reference numbers are used to represent the same or similar elements, and descriptions of the same technical contents are omitted.

Referring to FIGS. 4A and 4B, the main difference between a photoelectric sensing device 10c of the present embodiment and the photoelectric sensing device 10b is that the wiring layer M and the bias line BL belong to the different layers, and the wiring layer M is disposed between the planarization layer PFA and the substrate SB.

In the present embodiment, the wiring layer M and the lower electrode BE of the photoelectric sensing element PS belong to the same layer. Therefore, the wiring layer M is located below the planarization layer PFA and could be partially covered by the planarization layer PFA. In the present embodiment, the wiring layer M could be electrically connected to the bias line BL through a through hole V3 penetrating the planarization layer PFA, wherein the through hole V3 is located in the area 10A, but the disclosure is not limited thereto. In other embodiments, the wiring layer M and the source S and the drain D of the transistor T could belong to the same layer. In another embodiments, the wiring layer M and the gate G of the transistor T could belong to the same layer.

Based on the above, when the scintillator layer SC is formed by performing the evaporation process, the evaporation jig covering the area 10B is difficult to affect the wiring layer M since the wiring layer M is not disposed on the planarization layer PFA in the area 10B. Therefore, the possibility of disconnection of the wiring layer M located in the area 10B could be lowered.

However, in other embodiments, the through hole V3 penetrating the planarization layer PFA could be located in the sub-area 10B1 of the area 10B. In this case, the wiring layer M is located below the planarization layer PFA in the area 10B. Therefore, in the area 10B, a surface area of the bias line BL located above the planarization layer PFA should be smaller than a surface area of the wiring layer M located below the planarization layer PFA in the top view direction z of the photoelectric sensing device 10c. For example, a ratio of the surface area of the bias line BL located above the planarization layer PFA to the surface area of the wiring layer M located below the planarization layer PFA is less than one-ninth, but the disclosure is not limited thereto.

In another embodiments, the bias line BL is transferred to the wiring layer M located below the planarization layer PFA in the sub-area 10B2 of the area 10B. Similarly, in the area 10B, the surface area of the bias line BL located above the planarization layer PFA should be smaller than the surface area of the wiring layer M located below the planarization layer PFA in the top view direction z of the photoelectric sensing device 10c.

In summary, in the photoelectric sensing device provided by the embodiment of the disclosure, the area where the scintillator layer is located is defined as the first area, and the area other than the first area is defined as the second area. When the scintillator layer is formed by performing the evaporation process, the evaporation jig covering the second area is difficult to affect the planarization layer since the planarization layer is not located in the second area. Therefore, the possibility of damage to the planarization layer could be lowered, so as to reduce the disconnection of the wiring layer located on the planarization layer, thereby improving the reliability of the photoelectric sensing device provided by the embodiment of the disclosure.

In the photoelectric sensing device provided by other embodiment of the disclosure, the second area is further divided into a first sub-area and a second sub-area, wherein the planarization layer is located in the first sub-area but not located in the second sub-area. When the scintillator layer is formed by performing the evaporation process, the planarization layer located in the first sub-area may be affected by the evaporation jig and may be damaged. However, the possibility of disconnection of the wiring layer could be lowered since the surface area of the wiring layer located in the first sub-area is smaller than the surface area of the wiring layer located in the second sub-area, thereby improving the reliability of the photoelectric sensing device provided by other embodiment of the disclosure.

In the photoelectric sensing device provided by another embodiment of the disclosure, the wiring layer is disposed between the planarization layer and the substrate (that is, the wiring layer is located below the planarization layer), and is electrically connected to the bias line through the through hole disposed in the first area. When the scintillator layer is formed by performing the evaporation process, the planarization layer located in the second area may be affected by the evaporation jig and may be damaged. However, the possibility of disconnection of the wiring layer could be lowered since the wiring layer in the second area is located below the planarization layer, thereby improving the reliability of the photoelectric sensing device provided by another embodiment of the disclosure.

What is claimed is:

1. A photoelectric sensing device, comprising:
a transistor, disposed on a substrate;
a photoelectric sensing element, disposed on the substrate and electrically connected to the transistor;
a planarization layer, disposed on the photoelectric sensing element and partially covering the photoelectric sensing element;
a bias line, disposed on the planarization layer in an active area and electrically connected to the photoelectric sensing element;
a scintillator layer, disposed on the planarization layer; and
a wiring layer, disposed between the bias line and a pad located in a peripheral area, and electrically connected to the bias line and the pad,
wherein the photoelectric sensing device comprises a first area and a second area, the first area is an area where the scintillator layer is located, and the second area is an area other than the first area,
wherein at least part of the wiring layer located in the second area is not covered by the planarization layer or is located below the planarization layer.

2. The photoelectric sensing device according to claim 1, wherein in a top view direction of the photoelectric sensing device, the planarization layer overlaps the scintillator layer, and a surface area of the planarization layer is smaller than a surface area of the scintillator layer.

3. The photoelectric sensing device according to claim 1, wherein in a top view direction of the photoelectric sensing device, a surface area of the planarization layer is greater than a surface area of the scintillator layer.

4. The photoelectric sensing device according to claim 1, wherein the second area includes a first sub-area and a second sub-area, the first sub-area is an area where the planarization layer is located, and the second sub-area is an area other than the first sub-area,
wherein in a top view direction of the photoelectric sensing device, a first surface area of the wiring layer located in the first sub-area is smaller than a second surface area of the wiring layer located in the second sub-area.

5. The photoelectric sensing device according to claim 4, wherein a ratio of the first surface area to the second surface area is less than one-ninth.

6. The photoelectric sensing device according to claim 1, wherein the wiring layer is located below the planarization layer, and the wiring layer is electrically connected to the bias line through a through hole penetrating the planarization layer.

7. The photoelectric sensing device according to claim 6, wherein the through hole penetrating the planarization layer is located in the first area.

8. The photoelectric sensing device according to claim 1, wherein the bias line is transferred to the wiring layer in the second area.

9. The photoelectric sensing device according to claim 8, wherein in a top view direction of the photoelectric sensing device, a third surface area of the bias line located in the second area is smaller than a fourth surface area of the wiring layer.

10. The photoelectric sensing device according to claim 9, wherein a ratio of the third surface area to the fourth surface area is less than one-ninth.

11. The photoelectric sensing device according to claim 1, wherein the transistor comprises:
a gate;
a gate dielectric layer, disposed on the gate; and
a semiconductor layer, disposed on the gate dielectric layer; and
a source and a drain, disposed on the semiconductor layer and electrically connected to the semiconductor layer.

12. The photoelectric sensing device according to claim 11, wherein the wiring layer and the gate belong to the same layer.

13. The photoelectric sensing device according to claim 11, wherein the wiring layer, the source and the drain belong to the same layer.

14. The photoelectric sensing device according to claim 11, further comprising:
a scan line, disposed on the substrate and electrically connected to the gate; and
a data line, disposed on the substrate and electrically connected to the drain.

15. The photoelectric sensing device according to claim 14, further comprising:
a first pad, disposed in the second area and electrically connected to the data line; and
a second pad, disposed in the second area and electrically connected to the bias line.

16. The photoelectric sensing device according to claim 1, wherein the photoelectric sensing element comprises:
a lower electrode;
an upper electrode, disposed on the lower electrode; and
a semiconductor, disposed between the lower electrode and the upper electrode.

17. The photoelectric sensing device according to claim 16, wherein the wiring layer and the lower electrode belong to the same layer.

18. The photoelectric sensing device according to claim 1, wherein the photoelectric sensing device is a direct-detection X-ray sensor or an indirect-detection X-ray sensor.

19. The photoelectric sensing device according to claim 1, wherein a material of the planarization layer is an organic material.

20. The photoelectric sensing device according to claim 1, wherein the scintillator layer is formed on the planarization layer by performing an evaporation process.
